(19) United States
(12) Patent Application Publication
(10) Pub. No.: US 2005/0200899 A1
(43) Pub. Date: Sep. 15, 2005

(54) Error diffusion processing method, image signal processing apparatus, printing apparatus, program, and data table structure

(76) Inventor: Soichi Kuwahara, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/071,495

(22) Filed: Mar. 3, 2005

(30) Foreign Application Priority Data
Mar. 4, 2004 (JP) 2004-060927

(51) Int. Cl. H04N 1/40

(52) U.S. Cl. 358/3.03

(57) ABSTRACT

An image signal processing apparatus includes a data table that is configured to associate values of pixel data that can be input for error diffusion with parameters used for error-diffusing the pixel data. The apparatus further includes a parameter reading unit that reads a parameter from the data table using a value of input pixel data to be error-diffused as a read address, the parameter being associated with the value of the input pixel data, and an error diffusion unit that error-diffuses the input pixel data using the read parameter.

### BACKGROUND OF THE INVENTION

1. Field of the Invention

The present invention relates to an error diffusion processing method and to an image signal processing apparatus that performs error diffusion. The present invention further relates to a printing apparatus using the image signal processing technique and to a program and a data table structure implementing the image signal processing technique.

2. Description of the Related Art

One conversion technique for converting multi-tone image data into data suitable for binary representation indicating the on and off states of each pixel is an error diffusion method. In the error diffusion method, a density error caused in binarization is stored and used for processing neighboring pixels. The error diffusion method allows density information to be stored even after binarization. For example, approximately three to eight tonal levels per pixel can be stored.

The error diffusion method is disclosed in Floyd, R. and Steinberg, L., “An Adaptive Algorithm for Spatial Gray Scale,” SID DIGEST, 1975. Another known technique for performing error diffusion with a simple structure is to calculate a sum of pixel data of a pixel to be processed and error data of neighboring pixels and to perform error diffusion using the sum as a read address.

However, the processing method described above can cause undesirable grayscale conversion due to the error data. For example, if boundary values with uneven pitches therebetween are given, a single density level can be allocated output values for three or more tones due to the error data, which is not desirable for a high quality image with less graininess.

### SUMMARY OF THE INVENTION

Accordingly, the present invention provides error diffusion processing suitable for pixel data to be processed irrespective of the processing conditions.

According to the present invention, a value of input pixel data to be error-diffused, instead of a sum of the value of pixel data and error data, is used as a read address to read parameters used for error diffusion of the pixel data in advance from a data table.

### BRIEF DESCRIPTION OF THE DRAWINGS

FIG. 1 is a diagram showing the concept of a parameter reading operation according to the present invention;

FIGS. 2A to 2H are an error diffusion table;

FIG. 3 is an illustration of the relationship between parameters;

FIG. 4 is a block diagram of a printer according to an embodiment of the present invention;

FIG. 5 is a block diagram of a printer according to an embodiment of the present invention; and

FIG. 6 is a block diagram of an image signal processing apparatus according to an embodiment of the present invention.

### DESCRIPTION OF THE PREFERRED EMBODIMENTS

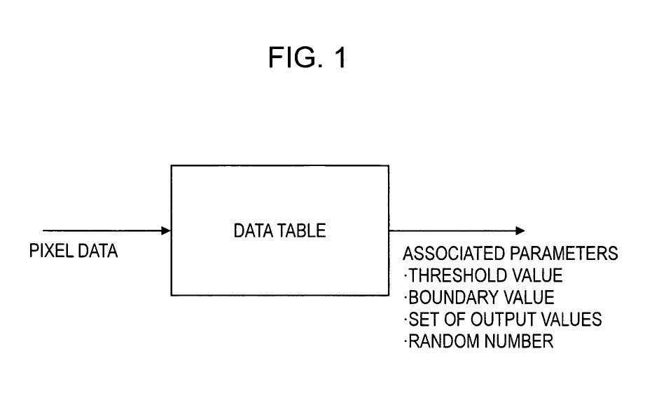

FIG. 1 shows the concept of error diffusion processing according to the present invention.

For example, a threshold value associated with a value of pixel data may be read from a data table. Alternatively, a boundary value associated with a value of pixel data may be read from a data table. A pair of output values associated with a value of pixel data may also be read from a data table. A random number associated with a value of pixel data may also be read from a data table.

Embodiments of the present invention will now be described. Portions that are not specifically described or illustrated in this document or the drawings refer to the state of the art. The following embodiments are merely examples, and the present invention is not limited to these embodiments.

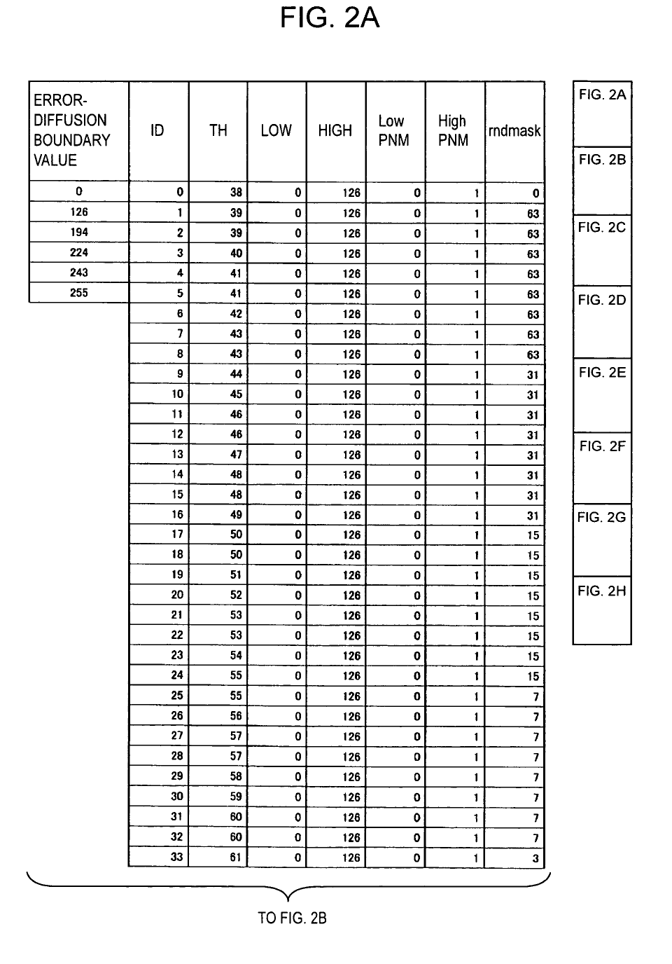

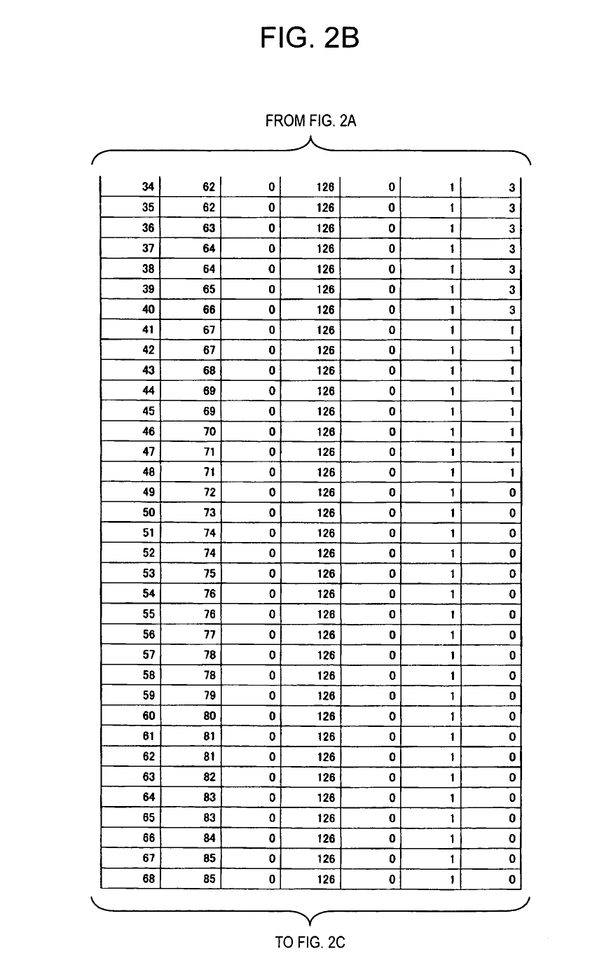

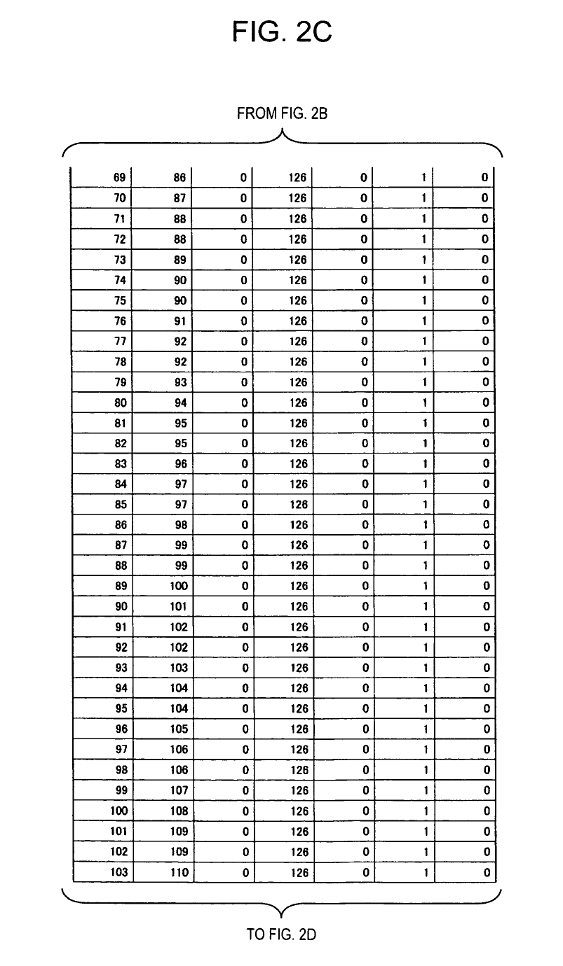

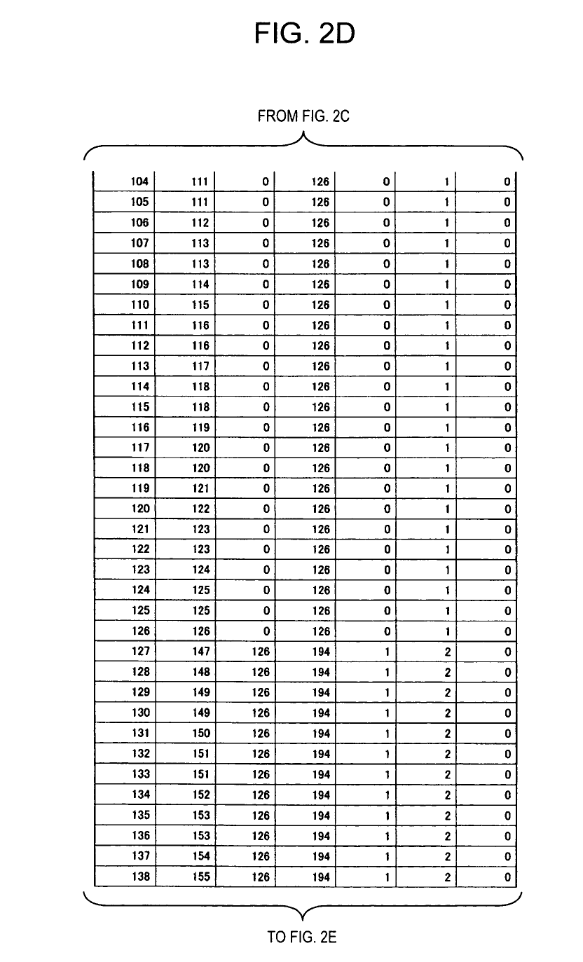

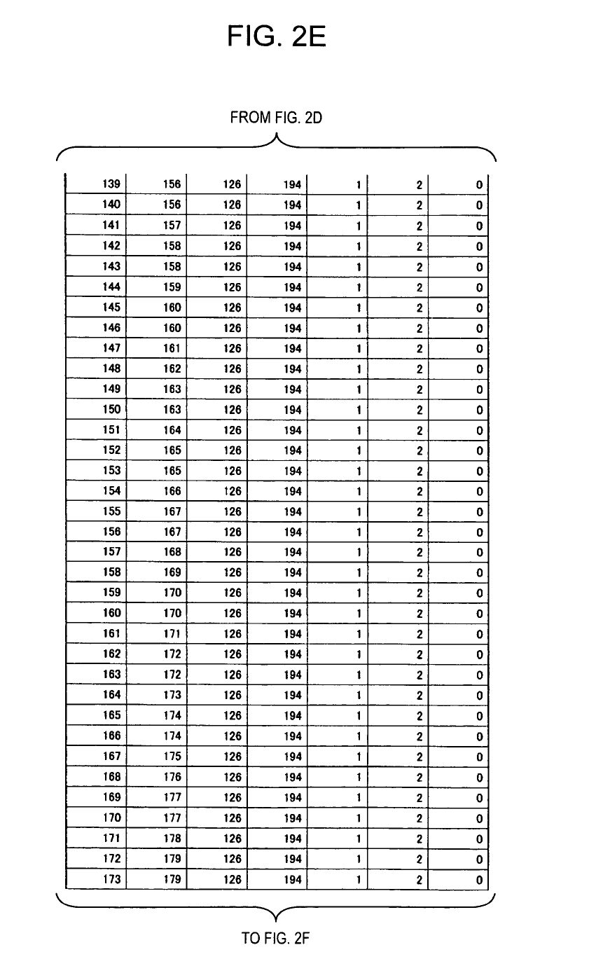

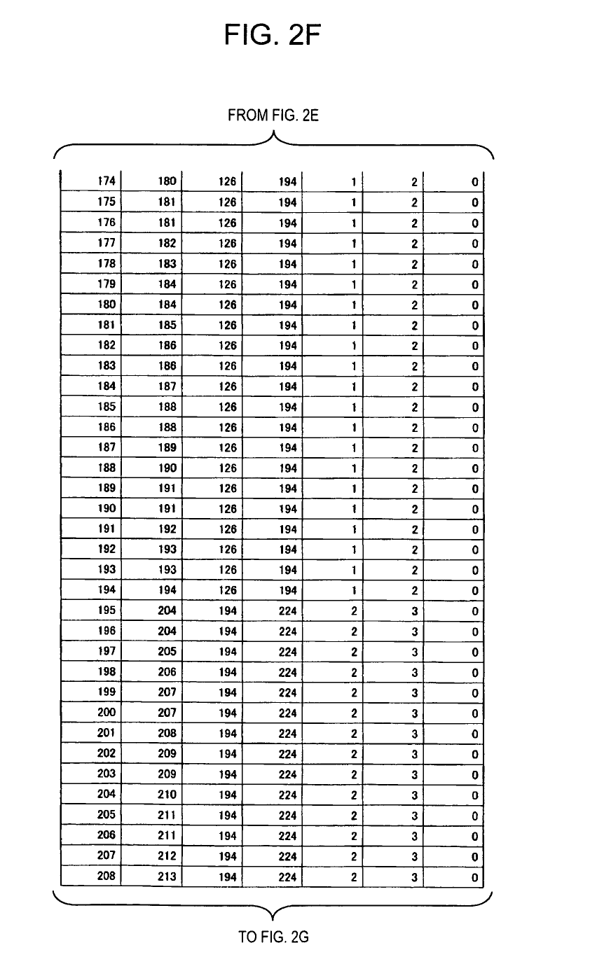

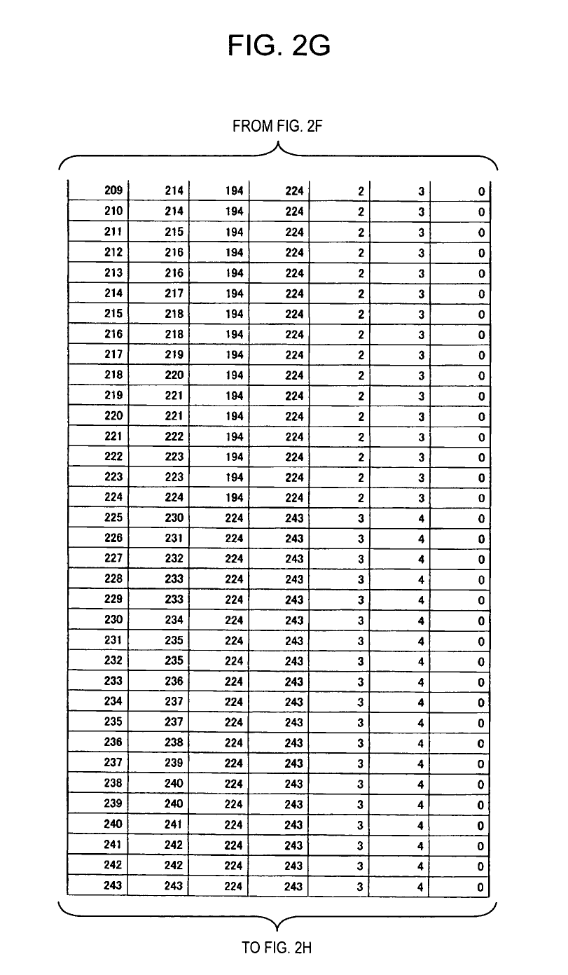

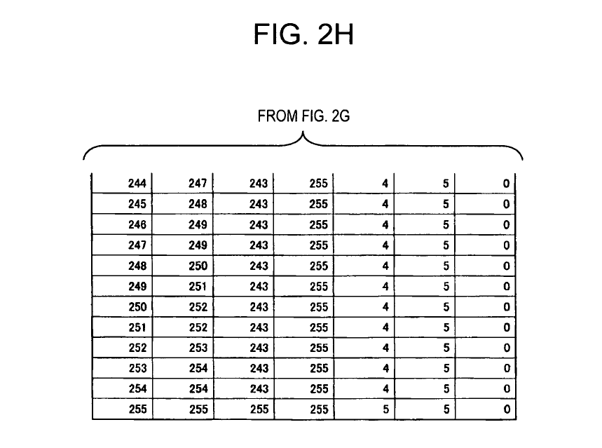

FIGS. 2A to 2H show an error diffusion table according to an embodiment of the present invention. The error diffusion table shown in FIGS. 2A to 2H is used to process pixel data ID having 256 tones (0 to 255) to output pixel data OD having 6 levels (0 to 5).

In this error diffusion table, the following six parameters are associated with the pixel data ID: a threshold value (TH) for error diffusion, boundary values (LOW/HIGH) for error diffusion, six-level output values (LowPNM/HighPNM), and a random number (rndmask).

For example, as shown in FIG. 2A, pixel data “22” is associated with threshold “53”, lower boundary “0”, upper boundary “126”, lower six-level output “0”, upper six-level output “1”, and random number “15”.

For example, as shown in FIG. 2D, pixel data “127” is associated with threshold “147”, lower boundary “126”, upper boundary “194”, lower six-level output “1”, upper six-level output “2”, and random number “0”.

For example, as shown in FIG. 2F, pixel data “195” is associated with threshold “204”, lower boundary “194”, upper boundary “224”, lower six-level output “2”, upper six-level output “3”, and random number “0”.

For example, as shown in FIG. 2G, pixel data “226” is associated with threshold “231”, lower boundary “224”, upper boundary “243”, lower six-level output “3”, upper six-level output “4”, and random number “0”.

For example, as shown in FIG. 2H, pixel data “250” is associated with threshold “252”, lower boundary “243”, upper boundary “255”, lower six-level output “4”, upper six-level output “5”, and random number “0”.

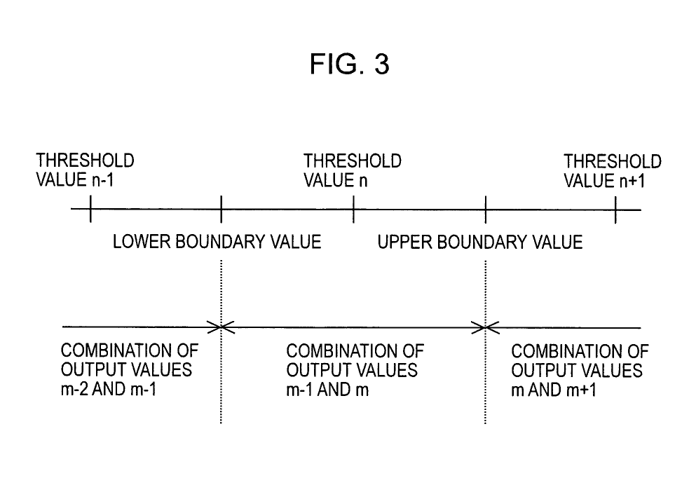

For reference, a relationship between the threshold value (TH), the two boundary values (LOW/HIGH), and the two six-level output values (LowPNM/HighPNM) is shown in FIG. 3. The threshold value (TH) is a reference value to be compared with a sum of input pixel data and error data of neighboring pixels.

Based on the threshold value (TH), the six-level output values (grayscale output values) basically associated with the input value (i.e., a sum of the pixel data and the error data) are determined. For example, when the input value is higher than the threshold value (TH), the associated upper six-level output value (e.g., “4”) is determined. For example, when the input value is lower than the threshold value (TH), the associated lower six-level output value (e.g., “3”) is determined.

In contrast, the two boundary values (LOW/HIGH) define a range of six-level output values to be output in combination. For example, when a given threshold value is between two boundary values, a combination of two six-level output values (e.g., upper six-level output “4” and lower six-level output “3”) associated with the given threshold value is output. The combination of six-level output values is changed beyond the boundary values.

In this example, when an input value is beyond the upper six-level output value, a combination of upper six-level output “5” and lower six-level output “4” is determined. When an input value is beyond the lower six-level output value, a combination of upper six-level output “3” and lower six-level output “2” is determined.

Therefore, the set of six-level output values is associated with pixel data, rather than with a sum of pixel data and error data. Thus, one of the two six-level output values basically associated with the pixel data can be output irrespective of the error data, resulting in a less grainy output image.

Moreover, the error diffusion table including parameters necessary for error diffusion can reduce the processing time required for error diffusion because the parameters do not need to be determined by calculation.

The random number (rndmask) is a value to be multiplied by the threshold value (TH) or error data for error diffusion. The random number is useful to reduce the graininess caused by noise, etc., and is particularly useful for a highlighted portion (or a low-pixel-data portion).

In the present embodiment, the four parameter types, i.e., a total of six parameters, are stored in the error diffusion table so as to be associated with the pixel data. The associated parameters stored in the error diffusion table may be read simultaneously using the pixel data as a read address, or may be read individually.

A table is configured such that parameters necessary for error diffusion are associated with pixel data. A plurality of error diffusion tables corresponding to different conversion characteristics allow the input/output characteristic to be changed by changing the error diffusion tables.

That is, by merely changing a set of parameters to be associated with the pixel data, a single hardware component or a single processing program can function as a plurality of error diffusion processors having different conversion characteristics.

A printer using the error diffusion table described above according to an embodiment of the present invention will now be described in the context of an ink jet printer. The printing apparatus according to the present invention may include a wide variety of printing apparatuses, such as a wire dot printer, a thermal transfer printer, and other printing apparatuses for use in printing in units of dots.

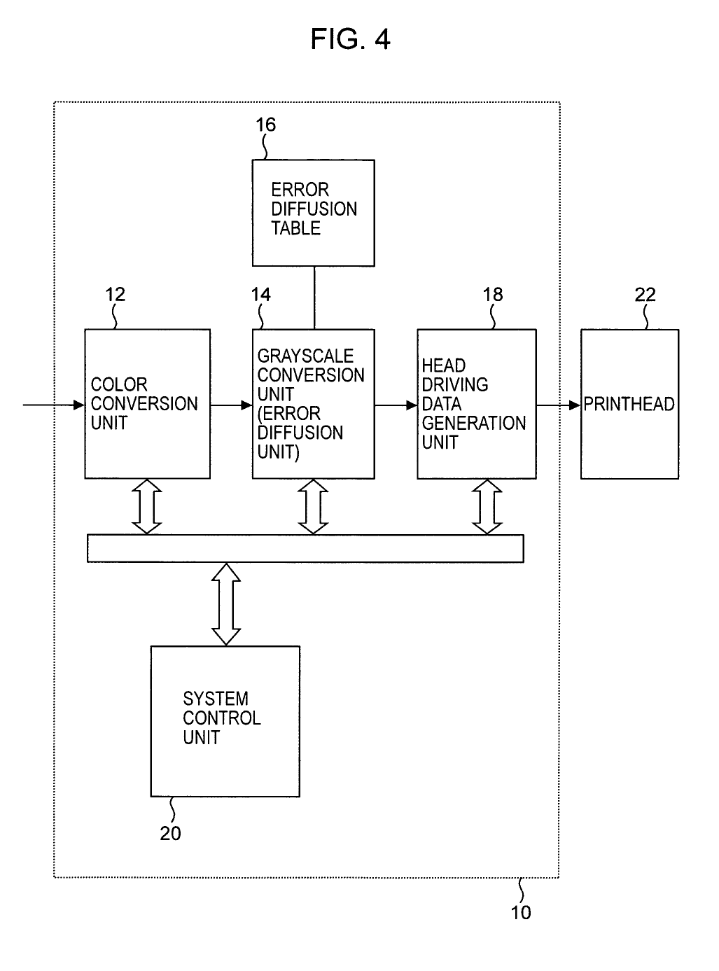

FIG. 4 shows an ejection controller 10 disposed in the printer. The ejection controller 10 is a signal processor for converting print data obtained from inside or outside the printer into grayscale data suitable for ejecting ink droplets. The ejection controller 10 includes a color conversion unit 12, a grayscale conversion unit 14, an error diffusion table 16, a head driving data generation unit 18, and a system control unit 20.

The color conversion unit 12 converts print data composed of additive primary colors, i.e., red (R), green (G), and blue (B), into density signals for printer ink colors, i.e., cyan (C), magenta (M), yellow (Y), and black (K).

The converted density signals are supplied from the color conversion unit 12 to the grayscale conversion unit 14. The grayscale conversion unit 14 performs signal processing to reduce the number of tones of the density signals. The grayscale conversion unit 14 converts the density signals into grayscale data with a fewer tones while ensuring high reproducibility of mid-level tones of the original image. This conversion is performed using the error diffusion table 16 described above (see FIGS. 2A to 2H).

The grayscale converter 14 reads parameters necessary for error diffusion from the error diffusion table 16 using the pixel data as a read address, and performs error diffusion according to a known procedure. The error diffusion table 16 is, for example, a semiconductor memory, a magnetic storage medium, an optical storage medium, or any other storage medium.

The error diffusion table 16 may be fixed to the printer or may be removable with respect to the printer. The error diffusion table 16 may also be implemented as a portion of a storage area for other information, e.g., firmware of the printer, other programs, and setting information.

The head driving data generation unit 18 generates head driving data for actually driving a printhead 22. The printhead 22 is driven by the head driving data to eject ink droplets from ejection units.

The system control unit 20 controls the overall printer. For example, the system control unit 20 detects a printing mode, and controls the components according to the detected printing mode. The system control unit 20 further controls driving of a feeding mechanism. The system control unit 20 is configured by a computer for controlling the components according to predetermined firmware.

A basic error diffusion operation performed in the printer will now be described. First, an error-diffusion threshold value (TH) is read from the error diffusion table 16 using the value of input pixel data (ID) as a read address.

Then, as in known error diffusion processing, a sum of the pixel data (ID) and an error (G) of a neighboring processed pixel is compared with the threshold value (TH). That is, an error-corrected input value (ID+G) and the threshold value (TH) are compared.

If the error-corrected input value is greater than the threshold value, i.e., ID+G>TH, the upper six-level output (HighPNM) is read from the error diffusion table 16 using the value of the pixel data (ID) as a read address.

The read value is output data (OD) with respect to the input pixel data. The difference between the output data (OD) and the error-corrected input value (ID+G) is a new processing error (G1). The processing error (G1) is also stored in an error memory and is used for later pixel processing, as in the known error diffusion processing.

As in the known error diffusion processing, the error (G) to be applied to the pixel data is determined from processing error (G1) of a processed pixel by calculation so as to more strongly affect a pixel closer to the pixel to be processed.

If the error-corrected input value is smaller than the threshold value, i.e., ID+G<TH, the lower six-level output (LowPNM) is read from the error diffusion table 16 using the value of the pixel data (ID) as a read address.

Also in this case, the read value is output data (OD) with respect to the input pixel data. The difference between the output data (OD) and the error-corrected input value (ID+G) is a new processing error (G1) . The processing error (G1) is also stored in an error memory and is used for later pixel processing, as in the known error diffusion processing.

Accordingly, an error diffusion table including parameters associated with pixel data allows short-time grayscale conversion. Parameters suitable for processing conditions can be registered, thus avoiding an inconvenience in that a given grayscale value is associated with three or more six-level output values. Thus, a high-reproducibility output image can be obtained.

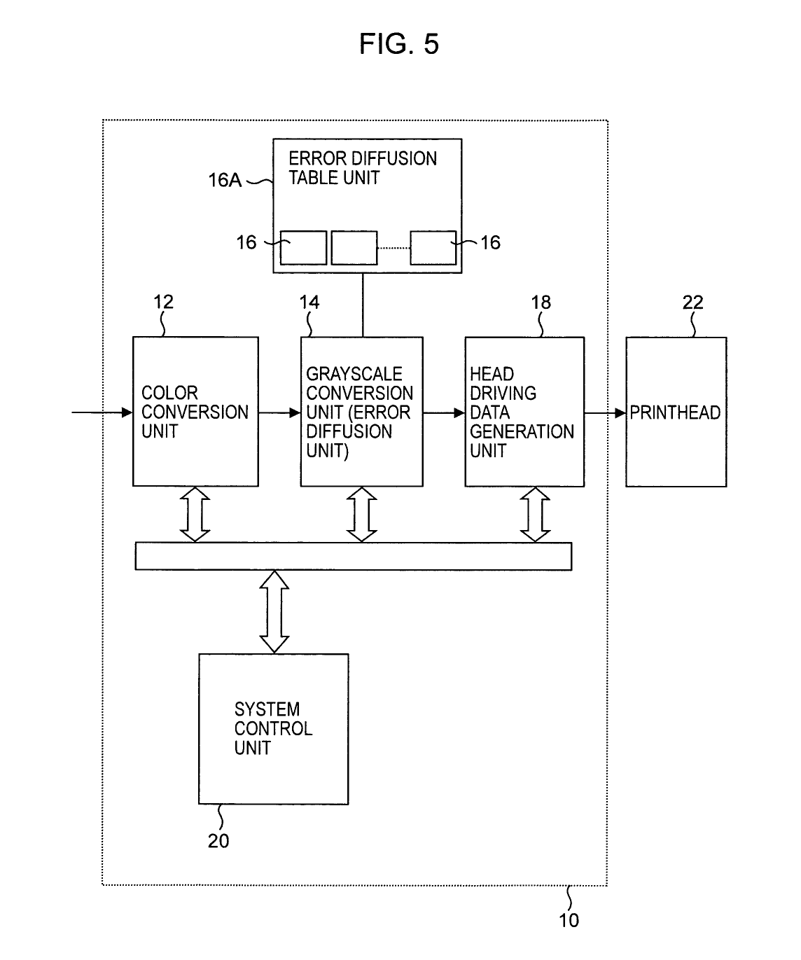

FIG. 5 shows a printer according to another embodiment of the present invention. In FIG. 5, corresponding portions to those shown in FIG. 4 are assigned the same reference numerals. The printer shown in FIG. 5 is different from the printer shown in FIG. 4 in that it includes an error diffusion table unit 16A that stores a plurality of error diffusion tables 16.

The error diffusion tables 16 have different sets of parameters associated with pixel data. The error diffusion tables 16 include sets of associated parameters optimum for specific processing conditions, e.g., text outputting applications, photograph outputting applications, video outputting applications, plain-paper applications, and special-paper applications.

In the printer shown in FIG. 5, the system controller 20 or the user needs to select one of the error diffusion tables 16 before performing error diffusion. Other operations are the same as those of the printer shown in FIG. 4. Thus, the conversion output optimum for the processing conditions can be implemented using the same hardware configuration and the same procedure for executing an error diffusion program.

The printer shown in FIG. 4 or 5 described above is configured such that print data supplied from inside or outside the printer is error-diffused by the printer itself. However, error diffusion may be performed by an apparatus separate from the printer, e.g., an image signal processing apparatus. For example, error diffusion is also used for applying various effects to an image or converting the image format.

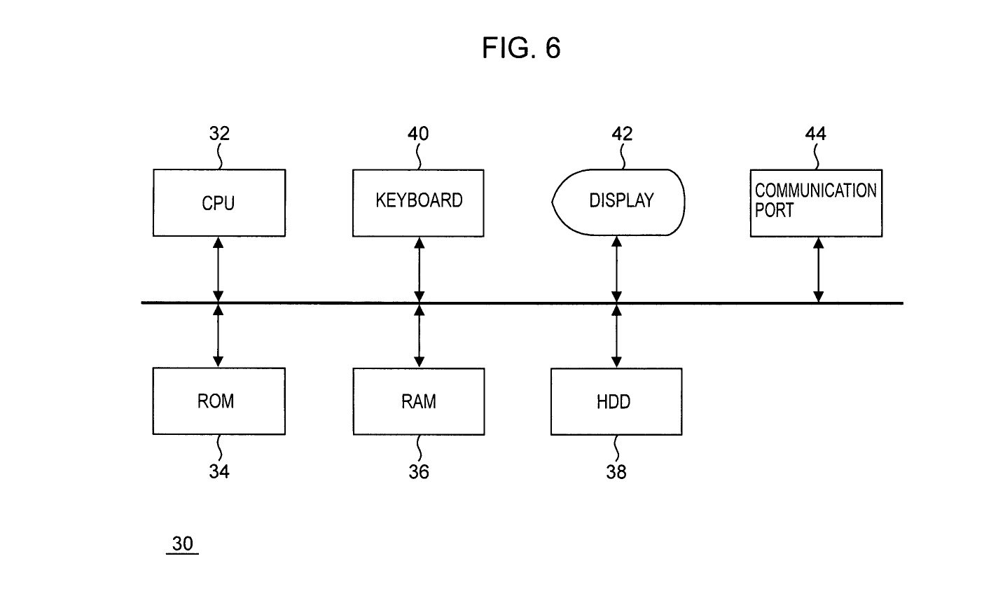

FIG. 6 is a block diagram of an image signal processing apparatus 30 according to an embodiment of the present invention. The image signal processing apparatus 30 has a known hardware configuration. The image signal processing apparatus 30 includes a central processing unit (CPU) 32, a read-only memory (ROM) 34, a random access memory (RAM) 36, a hard disk drive (HDD) 38, a keyboard 40, a display 42, and a communication port 44.

The CPU 32 executes a program using the RAM 34 as a work area. The program is executed to implement various functions. For example, a grayscale conversion function is implemented as one of the effects applied to an image. The RAM 36 is used as an area for executing an operation system and an application program.

The HDD 38 stores the operation system and the application program. The ROM 34 stores a basic input/output system (BIOS) program for input and output control with respect to peripheral devices.

The ROM 34 and the HDD 38 may also be used to store an error diffusion table. The error diffusion table is stored as a portion of a device driver or a portion of an application program.

The error diffusion table may also be stored in a semiconductor memory (including a memory card), an optical disk, or any other storage medium. The error diffusion table may also be stored in an external storage device (recording medium).

The keyboard 40 is an input device used by a user to input instructions or information to a computer. Another input device is, for example, a mouse. The display 42 is an output device for displaying a user interface designed using graphic components such as buttons and menu.

The user can instruct processing to be performed by the image processing apparatus 30 via the user interface view. The communication port 44 performs communication between the CPU 32 connected thereto via an internal bus and an ink jet printer.

The image signal processing apparatus 30 and the ink jet printer may be connected via a network using a network protocol compatible device as the communication port 44. The communication method may be wire or wireless communication.

The image signal processing apparatus 30 may be a general-purpose computer, a portable information terminal device incorporating a computer, a portable phone, a game device, an image pickup device, or any other electronic device.

The image signal processing apparatus 30 also allows appropriate parameters to be read using pixel data as a read address, thus realizing high-reproducibility grayscale conversion irrespective of the processing conditions. Thus, the image conversion characteristic can be improved.

Other Embodiments

While parameters associated with pixel data are stored in advance in an error diffusion table in the foregoing embodiments, the parameters may be determined from information, such as error-diffusion boundary values, and may be registered each time.

In the foregoing embodiments, four parameter types, i.e., a total of six parameters, are associated with pixel data and are registered in an error diffusion table. However, the parameter type and the number of parameters to be associated with pixel data are not limited thereto. For example, more parameter types may be associated, or, conversely, a fewer parameter types may be associated. The number of parameters to be associated may also be increased or decreased. The combination of parameters to be associated with pixel data is not limited to that described in the illustrated embodiments.

1-4. (canceled)

5. An image signal processing apparatus comprising:
at least one data table that is configured to associate values of pixel data that can be input for error diffusion with threshold values used for error-diffusing the pixel data;
a threshold value reading unit that reads a threshold value from the data table using a value of input pixel data to be error-diffused as a read address, the threshold value being associated with the value of the input pixel data; and
an error diffusion unit that error-diff-uses the input pixel data using the read threshold value.

6. An image signal processing apparatus comprising:
at least one data table that is configured to associate values of pixel data that can be input for error diffusion with boundary values used for error-diffusing the pixel data;
a boundary value reading unit that reads a boundary value from the data table using a value of input pixel data to be error-diffused as a read address, the boundary value being associated with the value of the input pixel data; and
an error diffusion unit that error-diffuses the input pixel data using the read boundary value.

7. An image signal processing apparatus comprising:
at least one data table that is configured to associate values of pixel data that can be input for error diffusion with pairs of output values that can be output as error-diffused pixel data;
an output value reading unit that reads a pair of output values from the data table using a value of input pixel data to be error-diffused as a read address, the pair of output values being associated with the value of the input pixel data; and
an error diffusion unit that error-diffuses the input pixel data and that outputs one of the read pair of output values that corresponds to the error-diffused pixel data.

8. An image signal processing apparatus comprising:
at least one data table that is configured to associate values of pixel data that can be input for error diffusion with random numbers used for error-diffusing the pixel data;
a random number reading unit that reads a random number from the data table using a value of input pixel data to be error-diffused as a read address, the random number being associated with the value of the input pixel data; and
an error diffusion unit that error-diffuses the input pixel data using a value obtained by multiplying the read random number with a threshold value or error data used for error diffusion.

9. The image signal processing apparatus according to claim 5, wherein the at least one data table comprises a plurality of data tables corresponding to error diffusion processing conditions, and
the threshold value associated with the input pixel data is read from the data table corresponding to an error diffusion processing condition that is selected when the input pixel data is error-diffused.

10. The image signal processing apparatus according to claim 6, wherein the at least one data table comprises a plurality of data tables corresponding to error diffusion processing conditions, and
the boundary value associated with the input pixel data is read from the data table corresponding to an error diffusion processing condition that is selected when the input pixel data is error-diffused.

11. The image signal processing apparatus according to claim 7, wherein the at least one data table comprises a plurality of data tables corresponding to error diffusion processing conditions, and
the pair of output values associated with the input pixel data is read from the data table corresponding to an error diffusion processing condition that is selected when the input pixel data is error-diffused.

12. The image signal processing apparatus according to claim 8, wherein the at least one data table comprises a plurality of data table corresponding to error diffusion processing conditions, and
the random number associated with the input pixel data is read from the data table corresponding to an error diffusion processing condition that is selected when the pixel data is error-diffused.

13-24. (canceled)
